(19) United States
(12) Patent Application Publication
(10) Pub. No.: US 2026/0092948 A1
(43) Pub. Date: Apr. 2, 2026

(54) Shock Logger

(71) Applicant: SEIKO EPSON CORPORATION, Tokyo (JP)

(72) Inventors: Ryuta NISHIZAWA, Nagano (JP); Taichi FUJINAMI, Minowa (JP); Takeru SAKAIDE, Minowa (JP); Shoei NOMURA, Minowa (JP); Sanshiro TAKESHITA, Shiojiri (JP)

(21) Appl. No.: 19/341,501

(22) Filed: Sep. 26, 2025

(30) Foreign Application Priority Data
Sep. 27, 2024 (JP) 2024-169414

(51) Int. Cl. G01P 15/125; G01K 7/22; G01P 15/18

(52) U.S. Cl. CPC G01P 15/125; G01K 7/22; G01P 15/18

(57) ABSTRACT

A shock logger includes an acceleration sensor; a circuit element including a timing circuit that generates time data, a sensor circuit that processes a signal output from the acceleration sensor, and a memory circuit that stores process data processed by the sensor circuit and the time data in relation to each other; and a package that houses the acceleration sensor and the circuit element. The shock logger has a natural vibration frequency less than 33 Hz or more than 100 Hz. The natural vibration frequency is preferably less than 25 Hz or more than 1 kHz or is more preferably less than 20 Hz or more than 10 kHz.

The present application is based on, and claims priority from JP Application Serial Number 2024-169414, filed Sep. 27, 2024, the disclosure of which is hereby incorporated by reference herein in its entirety.

### BACKGROUND

### 1. Technical Field

The present disclosure relates to shock loggers.

### 2. Related Art

JP-A-2019-152563 describes a shock detection device that can detect shocks, impacts, or other physical effects applied to a transported article. This shock detection device has a configuration in which an acceleration sensor, a real-time clock, an operation switch, a light emitting diode (LED), a storage unit, a wireless communication unit, a control unit, and a battery are disposed inside a housing, which is made of a translucent or transparent resin.

JP-A-2019-152563, however, fails to consider the natural vibration frequency (resonance frequency) of the shock detection device. Therefore, if a shock with a frequency close to the natural vibration frequency of the shock detection device is applied to the transported article, the shock detection device may resonate with this shock, thereby erroneously detecting a shock larger than the actual shock. As a result, the accuracy of detecting shocks may be lowered.

### SUMMARY

A shock logger according to an aspect of the present disclosure includes: an acceleration sensor; a circuit element including a timing circuit that generates time data, a sensor circuit that processes a signal output from the acceleration sensor, and a memory circuit that stores process data processed by the sensor circuit and the time data in relation to each other; and a package that houses the acceleration sensor and the circuit element. The shock logger has a natural vibration frequency less than 33 Hz or more than 100 Hz.

### BRIEF DESCRIPTION OF THE DRAWINGS

FIG. 1 is a top view of a shock logger according to a first embodiment.

FIG. 2 is a cross-sectional view taken along line II-II in FIG. 1.

FIG. 3 is an exploded perspective view of the arrangement of individual components inside a recess.

FIG. 4 is a top view of a vibrator element.

FIG. 5 is a top view of an acceleration sensor.

FIG. 6 is a block diagram illustrating circuits included in a circuit element.

FIG. 7 is a diagram illustrating an example of event data.

FIG. 8 is a diagram illustrating a shock vibration waveform.

FIG. 9 is a top view of a shock logger according to a second embodiment.

FIG. 10 is a cross-sectional view taken along line X-X in FIG. 9.

FIG. 11 is a cross-sectional view of a shock logger according to a third embodiment.

FIG. 12 is a top view of a shock logger according to a fourth embodiment.

FIG. 13 is a cross-sectional view taken along line XIII-XIII in FIG. 12.

FIG. 14 is a top view of a shock logger according to a fifth embodiment.

FIG. 15 is a top view of a shock logger according to a sixth embodiment.

FIG. 16 is a cross-sectional view of a shock logger according to a seventh embodiment.

### DESCRIPTION OF EMBODIMENTS

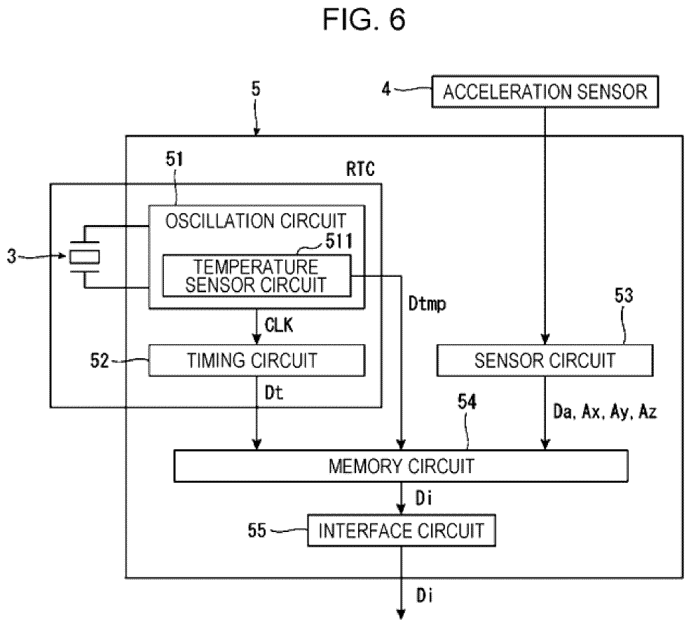

Hereinafter, a shock logger of the present disclosure will be described in detail based on embodiments illustrated in the accompanying drawings. For convenience of description, three mutually orthogonal axes are illustrated as an X-axis, a Y-axis, and a Z-axis in each of the drawings other than FIGS. 6 to 8. A direction along the X-axis is also referred to as an “X-axis direction”; a direction along the Y-axis is also referred to as a “Y-axis direction”; and a direction along the Z-axis is also referred to as a “Z-axis direction”. The arrow side of each axis is also referred to as the “positive side”, whereas the opposite side is also referred to as the “negative side”. In addition, the Z-axis extends in a vertical direction. The arrow side thereof is also referred to as the “upper side”, whereas the opposite side is also referred to as the “lower side”.

### First Embodiment

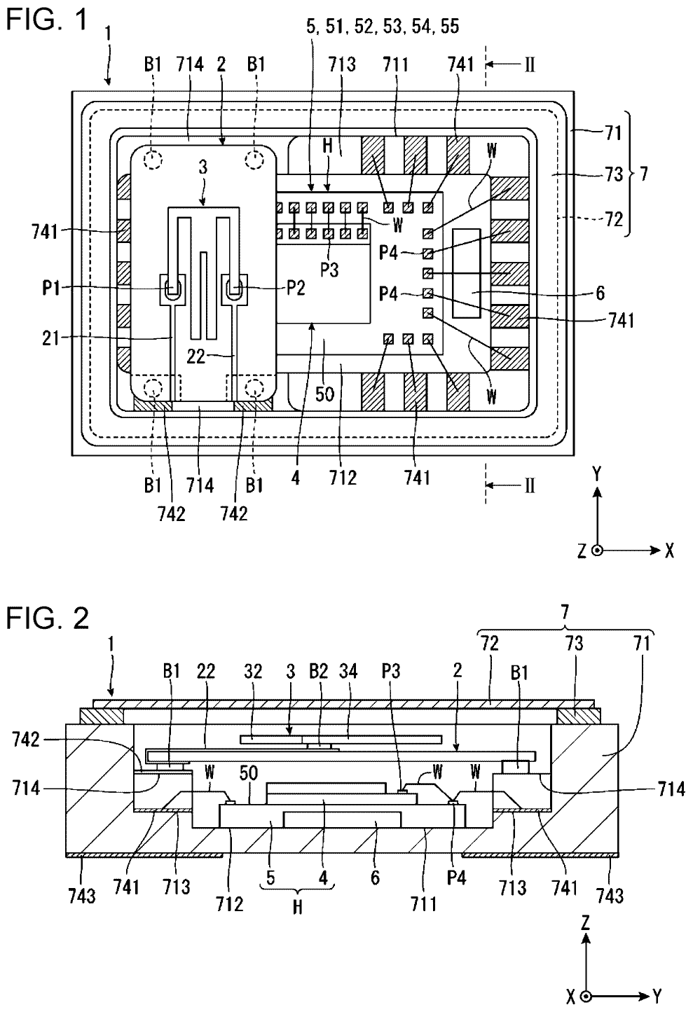

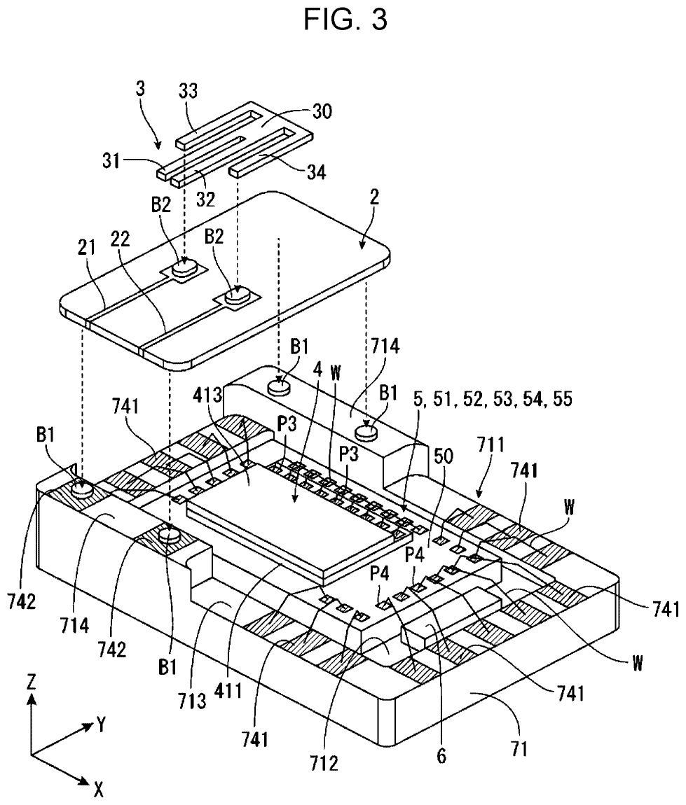

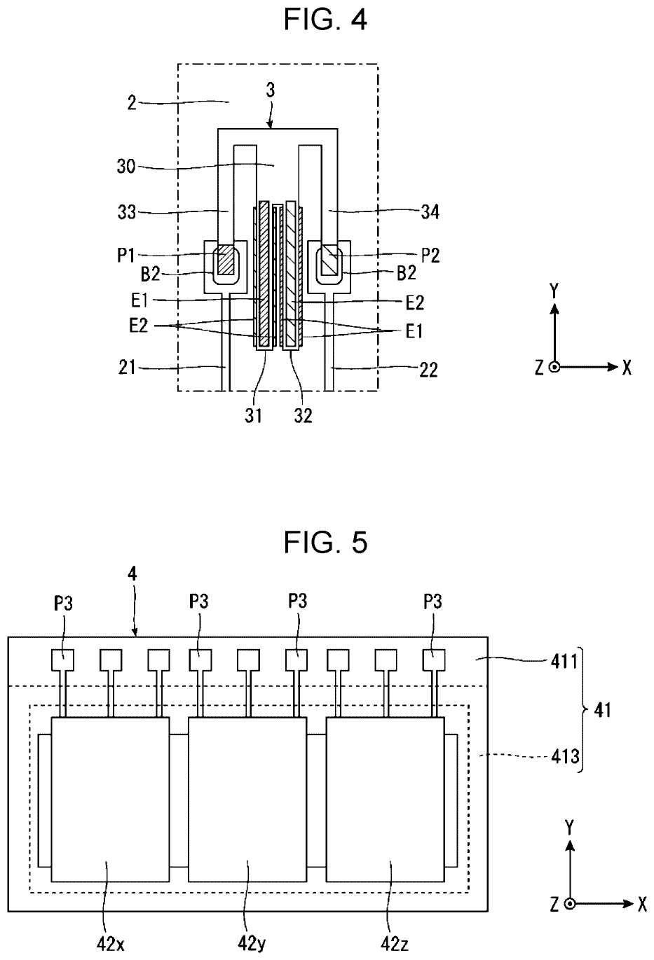

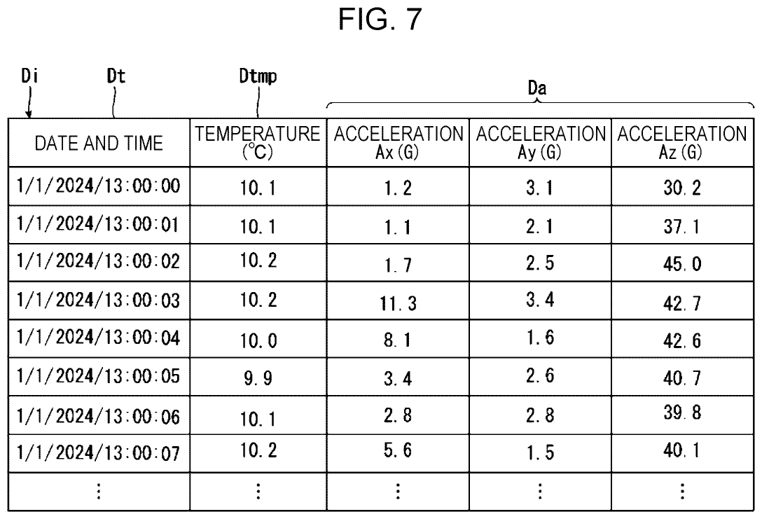

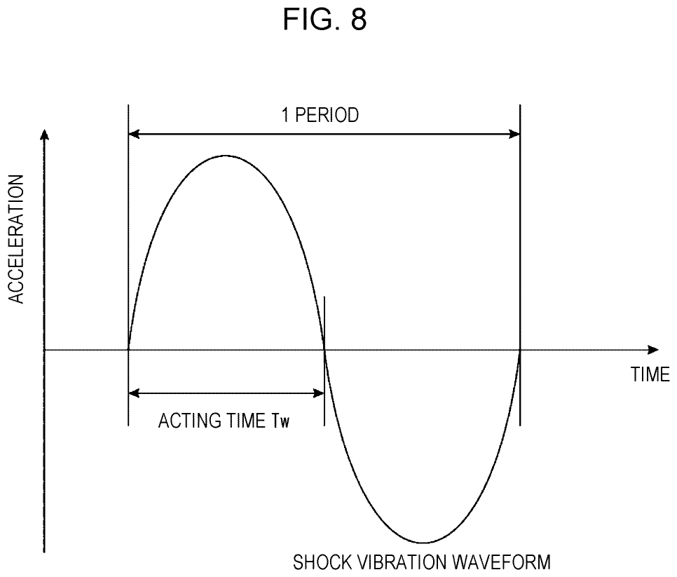

FIG. 1 is a top view of a shock logger according to a first embodiment. FIG. 2 is a cross-sectional view taken along line II-II in FIG. 1. FIG. 3 is an exploded perspective view of the arrangement of individual components inside a recess. FIG. 4 is a top view of a vibrator element. FIG. 5 is a top view of an acceleration sensor. FIG. 6 is a block diagram illustrating circuits included in the circuit element. FIG. 7 is a diagram illustrating an example of event data. FIG. 8 is a diagram illustrating a shock vibration waveform.

A shock logger 1 illustrated in FIG. 1 is mounted in an article to be transported, namely, a shock measurement target, and detects shocks, impacts, or other effects applied to the article and stores the detected shocks together with occurrence times thereof. With the shock logger 1 as described above, it can be found when and how much shock was applied to the article during the transportation.

If, for example, the article is damaged or broken during the transportation, the client (referred to as the manufacturer for convenience of description) who has requested the transportation of the article can clearly know what date and time the damage, breakage, or the like has occurred and find out, for example, the cause of the damage, the breakage, or the like and who is responsible for this incident. Thus, the manufacturer can easily take a next action against the transporter. Furthermore, by analyzing the shocks applied to the article during the transportation, the manufacturer can review the mechanical design of the article, thereby modifying the article so as to be more resistant to breakdowns. Moreover, the manufacturer can redesign the shape and size of an absorber for protecting the article from shocks. For example, if the downsizing of the absorber is possible as a result of the redesign, the article and transportation costs can be reduced accordingly.

On the other hand, the transporter who is responsible for transporting the article can effectively use data regarding the detected shocks as an evidence for proving that the transporter is not responsible for the damage, failure, or the like. Furthermore, the shock logger 1 is used to prove that a smaller number of shocks are applied to the article during the transportation by the manufacturer than by any other competitor. Based on this fact, the manufacturer can exhibit the high transportation quality, thereby achieving the differentiation from other transporters.

As described above, the shock logger 1 provides many advantages to both the client and the transporter. In particular, the shock logger 1 according to the present embodiment is less expensive and more compact, than shock loggers according to the related art (e.g., the shock detection device described in JP-A-2019-152563). In addition, the mounting of the shock logger 1 has substantially no effects on the overall cost and size. Therefore, it is possible to provide the shock logger 1 with great convenience.

As illustrated in FIG. 1, the shock logger 1 includes a support substrate 2, a vibrator element 3, an acceleration sensor 4, a circuit element 5, a battery 6, and a package 7 that houses these components. The shock logger 1 configured above is mounted in an article, for example, with a +Z-axis surface thereof facing the upper side in the vertical direction during the transportation.

### Package 7

First, the package 7 will be described. As illustrated in FIGS. 1 to 3, the package 7 includes: a base 71 formed into a cavity shape which has a recess 711 with an opening thereof facing upward; and a lid 72 formed into a planar shape which is joined to the upper surface of the base 71 with a seam ring 73 therebetween to cover the opening of the recess 711. With this configuration, the configuration of the package 7 is made simple. In addition, the package 7 defines an inner space, in which the support substrate 2, the vibrator element 3, the acceleration sensor 4, the circuit element 5, and the battery 6 are disposed. In this case, the inner space is hermetically enclosed and is kept in a reduced pressure state or preferably in a substantially vacuum state. This can reduce the viscous resistance of the inner space, enabling the vibrator element 3 efficiently to oscillate. However, the atmosphere of the inner space is not particularly limited.

A constituent material of the base 71 is not particularly limited; however, for example, various ceramics, such as aluminum oxide, can be used. A constituent material of the lid 72 is not particularly limited; however, a material with a linear expansion coefficient close to that of the constituent material of the base 71 may be used. For example, if the constituent material of the base 71 is a ceramic, an alloy such as Kovar is preferably used. With this configuration, the package 7 is made hard to enhance the mechanical strength of the shock logger 1. In addition, as will be described later, individual sections can be electrically interconnected via internal wires (not illustrated) formed in the base 71. Thus, wire substrates, for example, for electrical connections are unnecessary. Therefore, the shock logger 1 can be reduced in weight and size.

As illustrated in FIG. 2, the base 71 includes: a bottom surface 712 of the recess 711, a first step surface 713 that is positioned above the bottom surface 712 (on the +Z-axis side thereof) and is parallel to the bottom surface 712; and second step surfaces 714 each of which is positioned above the first step surface 713 (on the +Z-axis side thereof) and is parallel to the bottom surface 712. In plan view from the Z-axis direction, as illustrated in FIG. 1, the first step surface 713 has a frame shape surrounding the bottom surface 712. In addition, in plan view from the Z-axis direction, the two second step surfaces 714 are disposed separately so as to face each other in the Y-axis direction across the bottom surface 712. In this case, the second step surface 714 is disposed while shifted to the −X-axis side. The circuit element 5 and the battery 6 are arranged side by side in the X-axis direction on the bottom surface 712; the acceleration sensor 4 is disposed on the upper surface of the circuit element 5; the support substrate 2 is disposed on the second step surfaces 714; and the vibrator element 3 is disposed on the upper surface of the support substrate 2. However, the shapes of the first step surface 713 and the second step surfaces 714 are not particularly limited.

As illustrated in FIG. 1, a plurality of first internal terminals 741 are disposed on the first step surface 713, and a plurality of second internal terminals 742 are disposed on the second step surfaces 714. As illustrated in FIG. 2, a plurality of external terminals 743 are disposed on the lower surface of the base 71. Each of the plurality of first internal terminals 741 is electrically connected to a predetermined second internal terminal 742 or a predetermined external terminal 743 via an internal wire (not illustrated) formed in the base 71.

Furthermore, the first internal terminals 741 are electrically connected to the circuit element 5 via conductive wires W (bonding wires). The second internal terminals 742 are electrically connected to the vibrator element 3 via conductive bonding members B1 and wires 21 and 22 (described later) formed on the support substrate 2. The numbers of the first internal terminals 741, the second internal terminals 742, and the external terminals 743 and the arrangements thereof are not particularly limited; however, the numbers and arrangements may be appropriately determined, for example, in accordance with the numbers of terminals of the circuit element 5 and terminals of the vibrator element 3.

The size of the package 7 is not particularly limited; however, for example, it is preferable that (the length of the package 7 in the X-axis direction)×(the length of the package 7 in the Y-axis direction) is equal to or less than 10 mm×10 mm. In this way, the shock logger 1 can be made sufficiently compact. In the present embodiment, the size is about 7 mm×about 5 mm.

### Vibrator Element 3

As illustrated in FIG. 4, the vibrator element 3 is a tuning-fork type quartz crystal resonator. The vibrator element 3 is obtained by patterning a Z-cut quartz crystal substrate into a predetermined outer shape with etching or some other processes. The vibrator element 3 includes: a base section 30; a pair of vibrating arms 31 and 32 each of which extends from the base section 30 to the −Y-axis side; and a pair of support arms 33 and 34 each of which is formed into an L-shape and which extends from the base section 30. The vibrator element 3 is bonded to the upper surface of the support substrate 2 via conductive bonding members B2 at the tip end portions of the support arms 33 and 34. In addition, the vibrator element 3 includes: first excitation electrodes E1 disposed on the upper and lower surfaces of the vibrating arm 31 and both side surfaces of the vibrating arm 32; and second excitation electrodes E2 disposed on both side surfaces of the vibrating arm 31 and the upper and lower surfaces of the vibrating arm 32. Moreover, each of the first excitation electrodes E1 is electrically connected to a first connection terminal P1 disposed at the tip end portion of the support arm 33 via a wire (not illustrated). Each of the second excitation electrodes E2 is electrically connected to a second connection terminal P2 disposed at the tip end portion of the support arm 34 via a wire (not illustrated). In the vibrator element 3 configured above, when a drive signal (alternating voltage) is applied between the first excitation electrodes E1 and the second excitation electrodes E2 via the first connection terminal P1 and second connection terminal P2, the vibrating arms 31 and 32 perform in-plane vibrations by repeatedly moving close to or away from each other.

Although the vibrator element 3 has been described above, the configuration of the vibrator element 3 is not particularly limited. For example, a configuration using a quartz crystal substrate cut at an angle of, for example, AT-cut or SC-cut other than that of Z-cut may be employed.

### Support Substrate 2

As illustrated in FIG. 1, the support substrate 2 has a substantially rectangular planar shape having a certain thickness in the Z-axis direction, and the periphery thereof is bonded to the second step surfaces 714 via the conductive bonding members B1. In addition, the support substrate 2 is positioned under the vibrator element 3 and supports at the center thereof the vibrator element 3 from the bottom. The support substrate 2 has, in addition to a function of relaying electricity between the vibrator element 3 and the base 71, a function of absorbing or mitigating stress generated in response to deformation of the base 71 and thermal stress generated due to a difference in linear expansion coefficient, thereby suppressing such stress from being transmitted to the vibrator element 3.

The support substrate 2 configured above is formed of a quartz crystal substrate, similarly to the vibrator element 3. As a result, the support substrate 2 exhibits high mechanical strength. By forming the support substrate 2 with the same quartz crystal substrate as the vibrator element 3, the linear expansion coefficients of the support substrate 2 and the vibrator element 3 can be substantially equal to each other. As a result, thermal stress due to the difference in linear expansion coefficient between the support substrate 2 and the vibrator element 3 is not substantially generated. The vibrator element 3 is less likely to be stressed accordingly. Therefore, the driving of the vibrator element 3 is further stabilized. More specifically, the support substrate 2 is formed of the same Z-cut quartz crystal substrate as the vibrator element 3.

Furthermore, the orientations of the crystal axes thereof also coincide with those of the vibrator element 3. The quartz crystal has different linear expansion coefficients in the X-axis (electrical-axis) direction, the Y-axis (mechanical-axis) direction, and the Z-axis (optical-axis) direction. Thus, by cutting the support substrate 2 and the vibrator element 3 at the same angle and further aligning the orientations of the crystal axes thereof with one another, thermal stress as described above is even less likely to occur between the support substrate 2 and the vibrator element 3. As a result, the vibrator element 3 is even less likely to be stressed, and the driving of the vibrator element 3 is further stabilized.

The configuration of the support substrate 2 is not limited thereto. For example, the support substrate 2 may be formed of a quartz crystal substrate having the same cut angle as the vibrator element 3, but the orientations of the crystal axes may be different from those of the vibrator element 3. The support substrate 2 may be formed of a quartz crystal substrate having a cut angle different from that of the vibrator element 3. In addition, the support substrate 2 does not necessarily have to be formed of a quartz crystal substrate; alternatively, the support substrate 2 may be formed of, for example, a silicon substrate or a resin substrate. Moreover, the support substrate 2 may be, for example, a substrate for tape automated bonding (TAB) mounting which includes a support substrate and leads extending from the support substrate.

On the support substrate 2, the two wires 21 and 22 are disposed to electrically connect the first connection terminal P1 and the second connection terminal P2 included in the vibrator element 3 to the second internal terminals 742 disposed on the second step surface 714 of the base 71. First end portions of the wires 21 and 22 are electrically connected to the second internal terminals 742 via the conductive bonding member B1, and second end portions of the wires 21 and 22 are electrically connected to the first connection terminal P1 and the second connection terminal P2 via the conductive bonding members B2. The bonding members B1 and B2 are not particularly limited as long as the bonding members B1 and B2 have both conductivity and a joining property. For each of the bonding members B1 and B2, for example, various metal bumps such as gold bumps, silver bumps, copper bumps, or solder bumps, or a conductive adhesive in which a conductive filler such as a silver filler is dispersed in polyimide, epoxy, silicone-based, or acrylic adhesives can be used.

### Acceleration Sensor 4

The acceleration sensor 4 is a three-axis acceleration sensor that can detect an acceleration Ax in the X-axis direction, an acceleration Ay in the Y-axis direction, and an acceleration Az in the Z-axis direction.

The acceleration sensor 4 is a device of silicon micro electromechanical systems (MEMS). The acceleration sensor 4 can thereby be made compact.

As illustrated in FIG. 5, the acceleration sensor 4 includes: a package 41; and an X-axis acceleration sensor element 42x, a Y-axis acceleration sensor element 42y, and a Z-axis acceleration sensor element 42z, all of which are disposed inside the package 41. In addition, the package 41 includes: a base 411 that supports the sensor elements 42x, 42y, and 42z; and a lid 413 bonded to the upper surface of the base 411. The sensor elements 42x, 42y, and 42z are disposed between the base 411 and the lid 413. Furthermore, the base 411 is larger than the lid 413 so that a portion (or an end portion on the +Y-axis side) of the upper surface of the base 411 protrudes from the lid 413 to the outside.

In the portion of the upper surface of the base 411 which is exposed from the lid 413, a plurality of connection terminals P3 electrically connected to the sensor elements 42x, 42y, and 42z are disposed.

The acceleration sensor 4 configured above can be formed through a process including: for example, forming the base 411 from a first silicon layer (handle layer) of a silicon-on-insulator (SOI) substrate and forming the sensor elements 42x, 42y, and 42z from a second silicon layer (device layer); and bonding, to the base 411, the lid 413 formed from the silicon substrate. With this configuration, the acceleration sensor 4 can be fabricated by a manufacturing method conforming to a silicon semiconductor process.

Hereinafter, the X-axis acceleration sensor element 42x, the Y-axis acceleration sensor element 42y, and the Z-axis acceleration sensor element 42z will be described briefly.

The X-axis acceleration sensor element 42x includes: a fixed comb-shaped electrode fixed to the base 411; and a movable comb-shaped electrode that is disposed so as to interdigitate with the fixed comb-shaped electrode and that is displaceable in the X-axis direction with respect to the base 411. The fixed comb-shaped electrode and the movable comb-shaped electrode are disposed so as to face each other in the X-axis direction. When an acceleration Ax is applied to the X-axis acceleration sensor element 42x in the X-axis direction, the movable comb-shaped electrode is displaced in the X-axis direction. In accordance with this displacement, the capacitance between the fixed comb-shaped electrode and the movable comb-shaped electrode varies.

Then, the varying capacitance is taken out via the connection terminals P3 as an output signal. Based on this output signal, the acceleration Ax can be detected. It should be noted that the configuration of the X-axis acceleration sensor element 42x is not particularly limited as long as the acceleration Ax can be detected.

The Y-axis acceleration sensor element 42y has a configuration obtained by rotating the X-axis acceleration sensor element 42x by 90° around the Z-axis. In short, the Y-axis acceleration sensor element 42y has a fixed comb-shaped electrode fixed to the base 411 and a movable comb-shaped electrode that is disposed so as to interdigitate with the fixed comb-shaped electrode and that is displaceable in the Y-axis direction with respect to the base 411. The fixed comb-shaped electrode and the movable comb-shaped electrode are disposed so as to face each other in the Y-axis direction. When an acceleration Ay is applied to the Y-axis acceleration sensor element 42y in the Y-axis direction, the movable comb-shaped electrode is displaced in the Y-axis direction. In accordance with this displacement, the capacitance between the fixed comb-shaped electrode and the movable comb-shaped electrode varies. Then, the varying capacitance can be taken out from the connection terminal P3 as an output signal. Based on this output signal, the acceleration Ay can be detected. It should be noted that the configuration of the Y-axis acceleration sensor element 42y is not particularly limited as long as the acceleration Ay can be detected.

The Z-axis acceleration sensor element 42z has a fixed comb-shaped electrode fixed to the base 411 and a movable comb-shaped electrode that is disposed so as to interdigitate with the fixed comb-shaped electrode and that is displaceable in the Z-axis direction with respect to the base 411. When the acceleration Az is applied to the Z-axis acceleration sensor element 42z in the Z-axis direction, the movable comb-shaped electrode is displaced in the Z-axis direction. In accordance with this displacement, the capacitance between the fixed comb-shaped electrode and the movable comb-shaped electrode varies. Then, the varying capacitance can be taken out from the connection terminal P3 as an output signal. Based on this output signal, the acceleration Az can be detected. It should be noted that the configuration of the Z-axis acceleration sensor element 42z is not particularly limited as long as the acceleration Az can be detected.

As illustrated in FIGS. 1 to 3, the acceleration sensor 4 configured above is bonded to the upper surface of the circuit element 5 with a bonding member (not illustrated) therebetween. Each connection terminal P3 is electrically connected to the circuit element 5 via the conductive wire W (bonding wire).

The acceleration sensor 4 has been described above; however, the configuration of the acceleration sensor 4 is not particularly limited. For example, each of the base 411 and the lid 413 may be formed of a material, such as a glass material, other than silicon. In addition, a plurality of packages 41 may be disposed separately for the sensor elements 42x, 42y, and 42z. In this case, for example, the sensor elements 42x, 42y, and 42z may be stacked in the Z-axis direction. Furthermore, two or more sensor elements selected from the sensor elements 42x, 42y, and 42z may be integrally formed as a single sensor element. In other words, the configuration in which two or more of the accelerations Ax, Ay, and Az can be detected by a single sensor element may be employed. Moreover, the acceleration sensor 4 is not limited to a three-axis acceleration sensor having three acceleration detection axes; alternatively, the acceleration sensor 4 may have a configuration having two acceleration detection axes or a configuration having a single acceleration detection axis. In this case, preferably, the acceleration sensor 4 has at least the Z-axis acceleration sensor element 42z and can detect the acceleration Az in the Z-axis direction. With this configuration, shocks in the vertical direction, which are most likely to occur during the transportation and may cause a failure or other damage, can be more reliably detected.

Furthermore, the acceleration sensor 4 does not necessarily have to include the package 41, in which case the sensor elements 42x, 42y, and 42z may be exposed in the inner space of the package 7. With this configuration, the shock logger 1 can be made more compact.

### Circuit Element 5

As illustrated in FIGS. 1 to 3, the circuit element 5 is bonded to the bottom surface 712 of the recess 711 with a bonding member (not illustrated) therebetween.

The circuit element 5 is formed with a single chip. By forming the circuit element 5 from a single chip in this manner, the circuit element 5 can be made compact, for example, compared to a case where the circuit element 5 is formed of a plurality of chips as in an embodiment described later.

The circuit element 5 is disposed in an orientation in which an active surface 50 on which a plurality of connection terminals P4 are formed faces upward (in the +Z-axis direction). The acceleration sensor 4 is disposed on the active surface 50. In short, the circuit element 5 and the acceleration sensor 4 are stacked on the base 71. Of the plurality of connection terminals P4, some are electrically connected to the first internal terminals 741 disposed on the first step surface 713 of the base 71 via the corresponding wires W, and the remaining ones are electrically connected to the acceleration sensor 4 via the corresponding wires W. Hereinafter, the stacked body of the circuit element 5 and the acceleration sensor 4 is also referred to as a stacked body H.

By disposing the circuit element 5 on the bottom surface 712 and disposing the acceleration sensor 4 on the upper surface of the circuit element 5 in the above manner, a large area can be reserved for disposing the circuit element 5, enabling a larger circuit element 5 to be mounted thereon. Therefore, the circuit element 5 having higher performance can be mounted, or the circuit element 5 having more functions can be mounted. The configuration according to the present embodiment is effective, especially in a case where a programmable circuit element 5 that enables a user to customize functions as intended is mounted, because the circuit element 5 tends to be large in that case.

The circuit element 5, which is, for example, a micro controller unit (MCU), integrally controls each section in the shock logger 1. As illustrated in FIG. 6, the circuit element 5 includes: an oscillation circuit 51 of a temperature-compensated type which causes the vibrator element 3 to oscillate; a timing circuit 52 that generates time data Dt; a sensor circuit 53 that processes a signal output from the acceleration sensor 4 to determine the accelerations Ax, Ay, and Az; a memory circuit 54 that stores, as event data Di, the time data Dt and process data Da containing the accelerations Ax, Ay, and Az determined by the sensor circuit 53 in relation to each other; an interface circuit 55 that communicates with an external device; and a control circuit (not illustrated) that controls the individual circuits including the oscillation circuit 51 to the interface circuit 55.

The oscillation circuit 51 of a temperature-compensated type includes a temperature sensor circuit 511 that detects a temperature of the vibrator element 3. The configuration of the temperature sensor circuit 511 is not particularly limited; however, for example, the temperature sensor circuit 511 is a circuit provided with an NTC thermistor, which is a resistor whose resistance value varies with temperature and is a circuit which detects a temperature of the vibrator element 3 by using variations in the resistance value. Furthermore, the oscillation circuit 51 is electrically connected to the vibrator element 3, amplifies a signal output from the vibrator element 3, and feeds back the amplified signal to the vibrator element 3, thereby causing the vibrator element 3 to oscillate to generate a clock signal CLK. The frequency of the clock signal CLK is, for example, 32.768 kHz. Furthermore, the oscillation circuit 51 compensates for frequency-temperature characteristics of the clock signal CLK, based on the temperature of the vibrator element 3 detected by the temperature sensor circuit 511. More specifically, the temperature compensation is performed such that frequency variations in the clock signal CLK are smaller than the frequency-temperature characteristics of the vibrator element 3 itself. With this configuration, the frequency variations in the clock signal CLK due to the temperature change can be suppressed, so that the clock signal CLK can be generated with high precision.

As the oscillation circuit 51, for example, a Pierce oscillation circuit, an inverter-type oscillation circuit, a Colpitts oscillation circuit, a Hartley oscillation circuit, or other oscillation circuit can be used. The temperature compensation may be, for example, to tune the frequency of the clock signal CLK by adjusting the capacitance of a variable capacitance circuit connected to the oscillation circuit 51 or to use a PLL circuit or a direct digital synthesizer circuit to tune the frequency of the clock signal CLK generated by the oscillation circuit 51.

The clock signal CLK generated by the oscillation circuit 51 is subjected to frequency division by a frequency-dividing circuit (not illustrated) and then supplied to the timing circuit 52. For example, the frequency-division ratio of the frequency-dividing circuit is 32, and the frequency-division clock signal CLK has a frequency of 1.024 kHz. The timing circuit 52 performs clocking based on the clock signal CLK to generate the time data Dt. The time data Dt contains a second, a minute, an hour, a day, a month, and a year in time digits. In short, in the shock logger 1, the oscillation circuit 51 causes the vibrator element 3 to oscillate to generate the clock signal CLK, and the timing circuit 52 performs clocking based on the clock signal CLK to generate the time data Dt, which constitutes a real-time clock RTC. With this configuration, the time data Dt can be generated with high precision.

The sensor circuit 53 controls the drive of the acceleration sensor 4, determines the acceleration Ax, based on the signal output from the X-axis acceleration sensor element 42x, determines the acceleration Ay, based on the signal output from the Y-axis acceleration sensor element 42y, and determines the acceleration Az, based on the signal output from the Z-axis acceleration sensor element 42z.

Then, these accelerations Ax, Ay, and Az are output as the process data Da.

As illustrated in FIG. 7, for example, the memory circuit 54 stores the event data Di in which the process data Da (accelerations Ax, Ay, and Az) output from the sensor circuit 53 and the temperature data Dtmp detected by the temperature sensor circuit 511 are related to the time data Dt generated by the timing circuit 52. In short, the memory circuit 54 generates and stores the event data Di in which current times, shocks generated at those times, and temperatures at the times are related to each other within respective measurement periods. Therefore, it is possible to easily check the histories of applied shocks during the transportation, based on the event data Di. Consequently, it is possible to provide the shock logger 1 with a large amount of information, especially because the event data Di includes the temperature data Dtmp.

With the above configuration, the cause of a failure or other damage can be identified based on shocks during the transportation. In addition, it can be easily checked, based on the temperature data Dtmp, whether an article (particularly, an article that requires refrigeration or freezing) is constantly maintained within an appropriate temperature range during the transportation. Furthermore, it is possible to identify a failure due to exposure to excessively high temperatures or low temperatures during the transportation or a failure due to dew condensation caused by a rapid temperature change during the transportation. It should be noted that the memory circuit 54 does not necessarily have to store the event data Di for all the measurement periods. Alternatively, for example, the memory circuit 54 may store the event data Di when the acceleration Ax, Ay, or Az equal to or greater than a preset threshold value is detected. With this configuration, the capacity of the memory circuit 54 can be reduced.

The interface circuit 55 transmits and receives signals, receives an input (command) from an external device, and outputs the event data Di stored in the memory circuit 54. The communication method is not particularly limited; however, for example, serial peripheral interface (SPI) communication can be used.

### Battery 6

As illustrated in FIGS. 1 to 3, the battery 6 is joined to the bottom surface 712 of the recess 711 with a bonding member (not illustrated) therebetween. In addition, the battery 6 and the circuit element 5 are arranged side by side in the X-axis direction. The battery 6 supplies electric power to the circuit element 5. In short, the circuit element 5 is driven by the electric power supplied from the battery 6. Therefore, the shock logger 1 can operate without electric power externally supplied. The configuration of the battery 6 is not particularly limited; for example, a solid battery, a coin battery, or other type of battery can also be used.

The disposition of the battery 6 is not particularly limited. For example, the battery 6 may be disposed on the upper surface of the circuit element 5 together with the acceleration sensor 4 or may be disposed on the upper surface of the acceleration sensor 4.

The configuration of the shock logger 1 has been described above. In the shock logger 1 configured above, the vibrator element 3, the support substrate 2, the acceleration sensor 4, and the circuit element 5 are arranged side by side in the Z-axis direction. Furthermore, in plan view from the Z-axis direction, the vibrator element 3, the support substrate 2, the acceleration sensor 4, and the circuit element 5 overlap each other. With this configuration, the planar expansion of the shock logger 1 in the X-axis direction and the Y-axis direction, namely, the footprint thereof is reduced, so that it is possible to provide the shock logger 1 with compactness.

The shock logger 1 has a natural vibration frequency fr (resonance frequency) less than 33 Hz or more than 100 Hz. In short, fr<33 Hz or fr>100 Hz. By setting the natural vibration frequency fr within this range, the natural vibration frequency fr of the shock logger 1 can be made sufficiently apart from the frequencies of shocks to be applied to the article during the transportation. This can reduce the resonance of the shock logger 1 with a shock applied to the article during the transportation, thereby effectively suppressing the shock logger 1 from erroneously detecting a shock higher than the actual shock. Therefore, it is possible to effectively suppress a decrease in accuracy of detecting shocks by the shock logger 1.

The natural vibration frequency fr of the shock logger 1 may be less than 33 Hz or more than 100 Hz.

Preferably, the natural vibration frequency fr is less than 25 Hz or more than 1 kHz or more preferably less than 20 Hz or more than 10 kHz. In short, fr<25 Hz or fr>1 kHz is preferable; and, fr<20 Hz or fr>10 kHz is more preferable. By setting the natural vibration frequency fr to within this range, the natural vibration frequency of the shock logger 1 can be made further apart from the frequencies of shocks to be applied to the article during the transportation. This can effectively prevent the shock logger 1 from resonating with shocks during the transportation, thereby further effectively suppressing a decrease in accuracy of detecting shocks by the shock logger 1.

In a typical case, while an article (shock measurement target) is transported, the article is protected from shocks by an absorber. As a result of their diligent studies, the inventors have found that an acting time Tw over which shocks are being applied to an article via an absorber during the transportation is approximately about 5 ms to 14 ms. In this case, as illustrated in FIG. 8, the acting time Tw is defined as half the period of the vibration waveform of an applied shock. Thus, a shock with the acting time Tw of 5 ms has a period of 10 ms, which is equivalent to a shock having a frequency of 100 Hz.

Likewise, a shock with the acting time Tw of 14 ms has a period of 28 ms, which is equivalent to a shock having a frequency of 35.71 Hz. For these reasons, the frequency of a shock applied to an article during the transportation is typically in the range of 35.71 Hz or more and 100 Hz or less. In this case, since the natural vibration frequency fr of the shock logger 1 is less than 33 Hz or more than 100 Hz, as described above, the natural vibration frequency fr of the shock logger 1 does not fall within the range from 35.71 Hz to 100 Hz. In this way, the natural vibration frequency fr of the shock logger 1 can be made apart from the frequencies of shocks to be applied to the article during the transportation. Consequently, as described above, it is possible to effectively suppress the shock logger 1 from resonating with shocks during the transportation, thereby effectively suppressing a decrease in accuracy of detecting shocks by the shock logger 1.

As described above, by setting the natural vibration frequency fr to less than 25 Hz or more than 1 kHz, the above effect is made significant; by setting the natural vibration frequency fr to less than 20 Hz or more than 10 kHz, the effect is made more significant. Since the natural vibration frequency fr can be made further apart from the frequencies of shocks to be applied to the article during the transportation, the shock logger 1 can be more effectively suppressed from resonating with such shocks during the transportation. A decrease in accuracy of detecting shocks by the shock logger 1 can thereby be more effectively suppressed. The acting time Tw of a shock with a natural vibration frequency fr of 25 Hz is 20 ms, and the acting time Tw of a shock with a natural vibration frequency fr of 1 kHz is 0.5 ms. The acting time Tw of a shock with a natural vibration frequency fr of 20 Hz is 25 ms, and the acting time Tw of a shock with a natural vibration frequency fr of 10 kHz is 0.05 ms. Thus, by setting the natural vibration frequency fr to less than 25 Hz or more than 1 kHz, the shock logger 1 can be effectively suppressed from resonating with shocks with the acting time Tw of 0.5 ms to 20 ms. By setting the natural vibration frequency fr to less than 20 Hz or more than 10 kHz, the shock logger 1 can be effectively suppressed from resonating with shocks with the acting time Tw of 0.05 ms to 25 ms.

In the package 7 according to the present embodiment, as described above, the base 71 is made of various ceramics, and the lid 72 is made of a metal material such as Kovar. This can provide a package 7 with hardness, which increases the natural vibration frequency fr of the shock logger 1 accordingly. Therefore, the natural vibration frequency fr can be made sufficiently higher than the frequencies (33 Hz to 100 Hz) of shocks to be generated during the transportation. Since the circuit element 5 is formed with a single chip, as described above, the shock logger 1 can be made compact. By making the shock logger 1 compact, the natural vibration frequency fr of the shock logger 1 can be further increased. Therefore, the natural vibration frequency fr can be made sufficiently higher than the frequencies (33 Hz to 100 Hz) of shocks to be generated during the transportation.

The shock logger 1 has been described above. As described above, a shock logger 1 includes: a circuit element 5 including an acceleration sensor 4, a timing circuit 52 that generates time data Dt, a sensor circuit 53 that processes a signal output from the acceleration sensor 4, and a memory circuit 54 that stores process data Da processed by the sensor circuit 53 and the time data Dt in relation to each other; and a package 7 that houses the acceleration sensor 4 and the circuit element 5. The shock logger 1 has a natural vibration frequency fr less than 33 Hz or more than 100 Hz. With this configuration, the natural vibration frequency fr of the shock logger 1 can be made sufficiently apart from frequencies of shocks to be applied to an article (shock measurement target) during transportation. This can reduce the resonance of the shock logger 1 with a shock applied to the article during the transportation, thereby effectively suppressing the shock logger 1 from erroneously detecting a shock larger than the actual shock. Therefore, it is possible to effectively suppress a decrease in accuracy of detecting shocks by the shock logger 1.

As described above, the natural vibration frequency fr is less than 25 Hz or more than 1 kHz. With this configuration, the natural vibration frequency fr of the shock logger 1 can be made further apart from frequencies of shocks to be applied to the article (shock measurement target) during the transportation. Therefore, it is possible to more effectively suppress a decrease in accuracy of detecting shocks by the shock logger 1.

As described above, the natural vibration frequency fr is less than 20 Hz or more than 10 kHz. With this configuration, the natural vibration frequency fr of the shock logger 1 can be made even further apart from frequencies of shocks to be applied to the article (shock measurement target) during the transportation. Therefore, it is possible to even further effectively suppress a decrease in accuracy of detecting shocks by the shock logger 1.

As described above, the shock logger 1 includes a battery 6 that supplies electric power to the circuit element 5. This configuration enables the shock logger 1 to operate without electric power externally supplied.

As described above, the shock logger 1 includes a vibrator element 3 disposed inside the package 7, and the circuit element 5 includes an oscillation circuit 51 that causes the vibrator element 3 to oscillate. The oscillation circuit 51 causes the vibrator element 3 to oscillate to generate a clock signal CLK, and the timing circuit 52 performs clocking based on the clock signal CLK to generate time data Dt, so that the oscillation circuit 51 and the timing circuit 52 constitute a real-time clock RTC. With this configuration, the time data Dt can be generated with high precision.

As described above, the package 7 includes a base 71 on which the acceleration sensor 4 and the circuit element 5 are disposed. The acceleration sensor 4 and the circuit element 5 are disposed on the base 71 in a stacked state. With this configuration, the planar expansion of the shock logger 1 in the X-axis direction and the Y-axis direction, namely, the footprint thereof is reduced, so that it is possible to provide the shock logger 1 with compactness.

As described above, the circuit element 5 is disposed on the base 71, and the acceleration sensor 4 is disposed on the circuit element 5. With this configuration, a larger circuit element 5 can be mounted. Therefore, the circuit element 5 having higher performance can be mounted, or the circuit element 5 having more functions can be mounted.

As described above, the package 7 includes a lid 72 bonded to the base 71. The circuit element 5 and the acceleration sensor 4 are disposed between the base 71 and the lid 72. With this configuration, the configuration of the package is made simple.

As described above, the circuit element 5 includes a temperature sensor circuit 511 that detects temperature.

The memory circuit 54 stores temperature data Dtmp detected by the temperature sensor circuit 511, the process data Da, and the time data dt in relation to each other. This configuration can store temperatures in the shock logger 1 together with shocks, thereby providing the shock logger 1 with a large amount of information.

### Second Embodiment

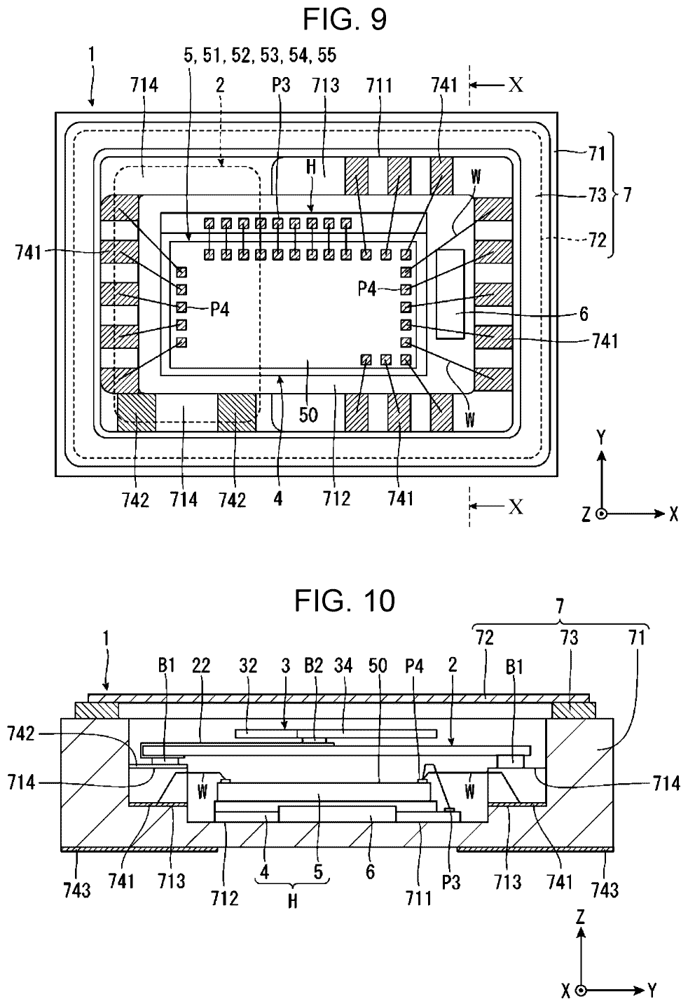

FIG. 9 is a top view of a shock logger according to a second embodiment. FIG. 10 is a cross-sectional view taken along line X-X in FIG. 9.

A shock logger 1 according to the present embodiment is the same as that according to the foregoing first embodiment, except for a configuration of a stacked body H. In the following description, the present embodiment will be described with a focus on differences from the foregoing first embodiment, and the description of the same matters will not be repeated. In addition, in each of the drawings according to the present embodiment, the same reference numerals are assigned to the same configurations as those according to the foregoing embodiment.

In the shock logger 1 according to the present embodiment, as illustrated in FIGS. 9 and 10, the stacking order of the stacked body H is opposite to that according to the first embodiment. An acceleration sensor 4 is disposed on a bottom surface 712 of a recess 711, and a circuit element 5 is disposed on the upper surface of the acceleration sensor 4. In short, the acceleration sensor 4 is disposed on a base 71, and the circuit element 5 is disposed on the acceleration sensor 4. By disposing the acceleration sensor 4 under the circuit element 5 in this manner, a large area can be reserved for disposing the acceleration sensor 4, enabling a larger acceleration sensor 4 to be mounted thereon. As a result, a large capacitance can be reserved between a fixed comb-shaped electrode and a movable comb-shaped electrode of each of sensor elements 42x, 42y, and 42z, for example, compared to the foregoing first embodiment. Consequently, it is possible to detect accelerations Ax, Ay, and Az more accurately.

In the shock logger 1 according to the present embodiment, as described above, the acceleration sensor 4 is disposed on the base 71, and the circuit element 5 is disposed on the acceleration sensor 4. With this configuration, a larger acceleration sensor 4 can be mounted. Consequently, it is possible to detect shocks (accelerations Ax, Ay, and Az) more accurately.

Such a second embodiment can produce the same effects as in the foregoing first embodiment.

### Third Embodiment

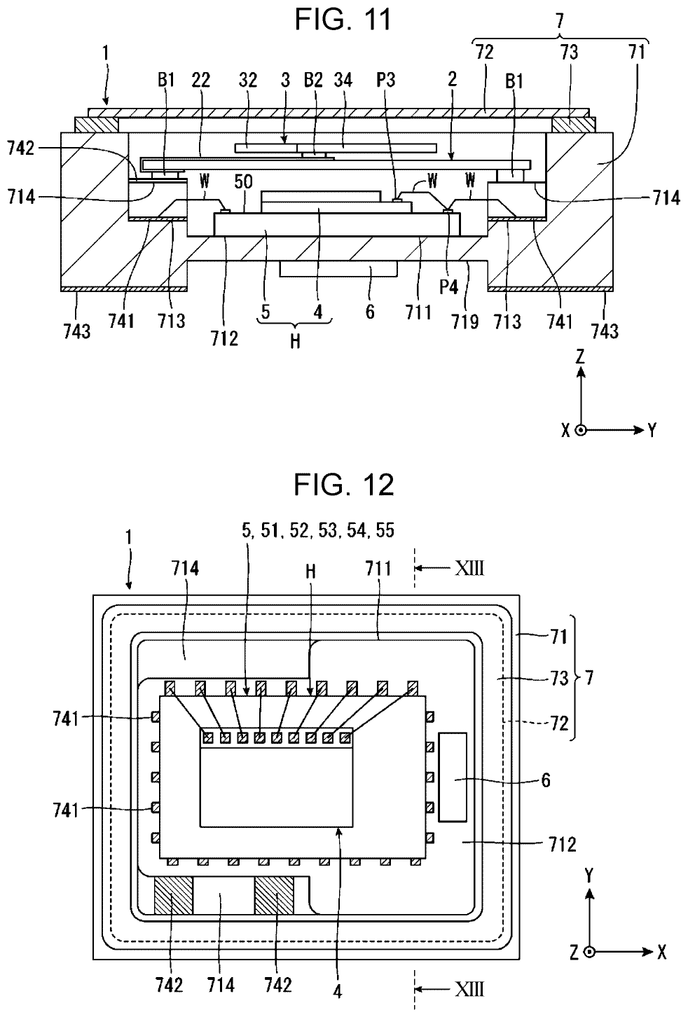

FIG. 11 is a cross-sectional view of a shock logger according to a third embodiment.

A shock logger 1 according to the present embodiment is the same as that according to the foregoing first embodiment, except for a configuration of a package 7 and a disposition of a battery 6. In the following description, the present embodiment will be described with a focus on differences from the foregoing first embodiment, and the description of the same matters will not be repeated. In addition, in the drawing according to the present embodiment, the same reference numerals are assigned to the same configurations as those according to the foregoing embodiment.

In the shock logger 1 according to the present embodiment, as illustrated in FIG. 11, a base 71 of the package 7 has a recess 711 that has an opening facing upward as well as a recess 719 that has an opening facing downward. The battery 6 is mounted in the recess 719 and disposed on the bottom surface of the recess 719. In this case, the battery 6 overlaps a circuit element 5 in plan view from the Z-axis direction. By disposing the battery 6 under the circuit element 5 in this manner, for example, the planar expansion of the shock logger 1 in the X-axis direction and the Y-axis direction can be further suppressed, compared to the foregoing first embodiment. The shock logger 1 can thereby be made more compact. With this configuration, the battery 6 can be easily replaced because the battery 6 is exposed from the package 7 to the outside. This facilitates long-term continuous use, reuse, or maintenance of the shock logger 1 through the replacement of the battery.

As described above, the shock logger 1 according to the present embodiment includes the battery 6 that supplies electric power to the circuit element 5. In addition, the battery 6 is exposed from the package 7 to the outside. With this configuration, the battery 6 can be easily replaced, facilitating long-term continuous use, reuse, or maintenance of the shock logger 1 through the replacement of the battery.

Such a third embodiment can produce the same effects as in the foregoing first embodiment.

### Fourth Embodiment

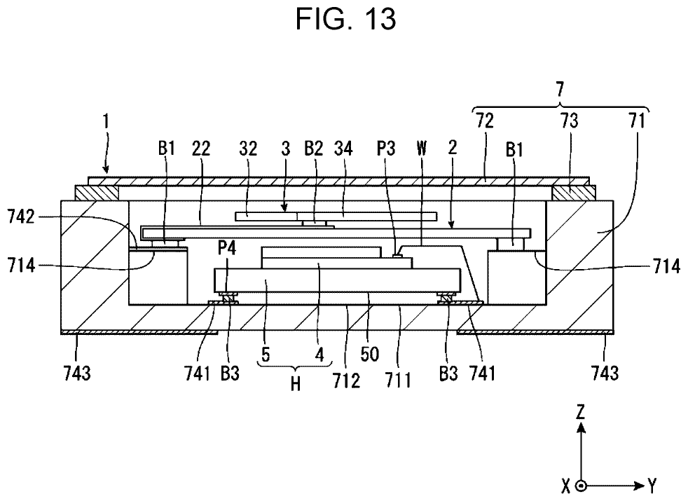

FIG. 12 is a top view of a shock logger according to a fourth embodiment. FIG. 13 is a cross-sectional view taken along line XIII-XIII in FIG. 12. In FIG. 12, for convenience of description, neither a support substrate 2 nor a vibrator element 3 is illustrated.

A shock logger 1 according to the present embodiment is the same as that according to the foregoing first embodiment, except for a method of mounting a circuit element 5. In the following description, the present embodiment will be described with a focus on differences from the foregoing first embodiment, and the description of the same matters will not be repeated. In addition, in the drawing according to the present embodiment, the same reference numerals are assigned to the same configurations as those according to the foregoing embodiment.

In the foregoing first embodiment, the circuit element 5 is bonded to the bottom surface 712 in a position in which the active surface 50 faces upward. In the present embodiment, however, the circuit element 5 is mounted on the bottom surface 712 via flip-chip bonding (FCB) in a position in which an active surface 50 faces downward, as illustrated in FIGS. 12 and 13. A plurality of first internal terminals 741 are disposed on the bottom surface 712. Connection terminals P4 of the circuit element 5 are electrically connected to the corresponding first internal terminals 741 via conductive bonding members B3, such as gold balls. With this configuration, the shock logger 1 can be made compact because a first step surface 713 is unnecessary.

Such a fourth embodiment can produce the same effects as in the foregoing first embodiment.

### Fifth Embodiment

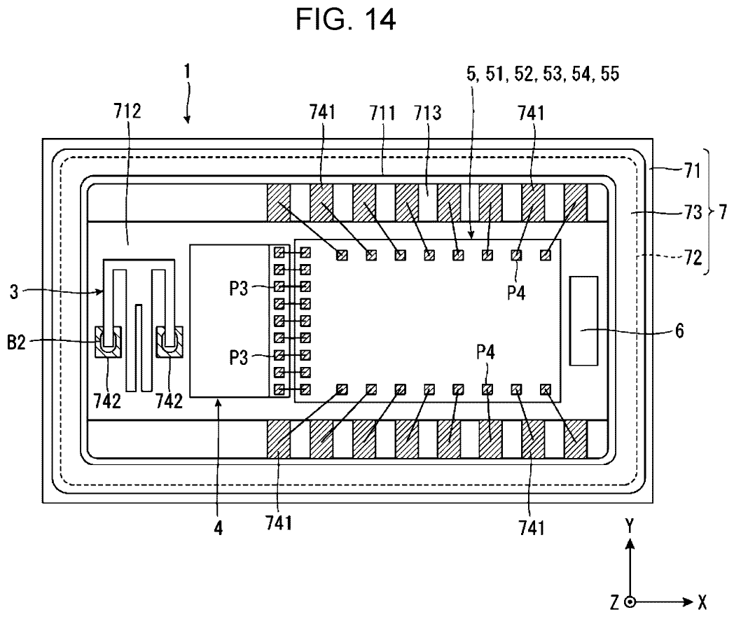

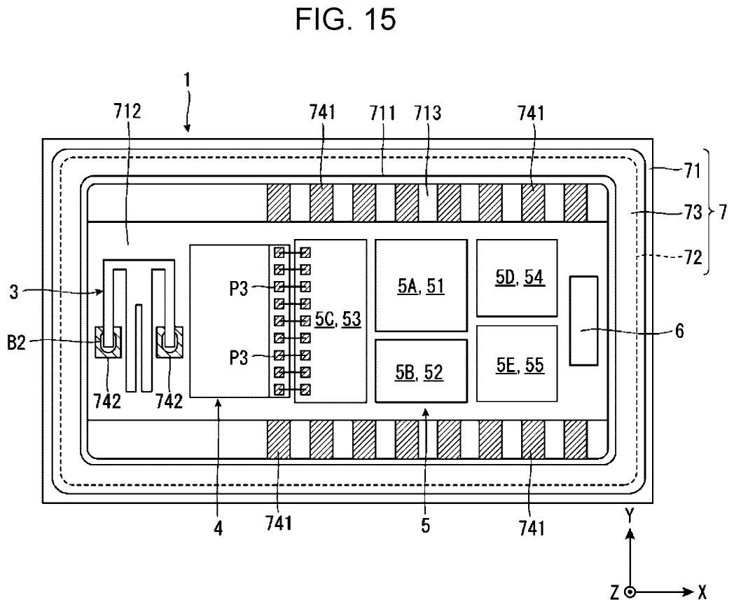

FIG. 14 is a top view of a shock logger according to a fifth embodiment.

A shock logger 1 according to the present embodiment is the same as that according to the foregoing first embodiment, except for an arrangement of individual sections within a package 7. In the following description, the present embodiment will be described with a focus on differences from the foregoing first embodiment, and the description of the same matters will not be repeated. In addition, in the drawing according to the present embodiment, the same reference numerals are assigned to the same configurations as those according to the foregoing embodiment.

In the shock logger 1 according to the present embodiment, as illustrated in FIG. 14, a support substrate 2 is not disposed, and a vibrator element 3, an acceleration sensor 4, a circuit element 5, and a battery 6 are disposed on a bottom surface 712 of a recess 711. In short, in the shock logger 1 according to the present embodiment, the vibrator element 3, the acceleration sensor 4, the circuit element 5, and the battery 6 are arranged in a planar fashion without being stacked on top of each other. With this configuration, the shock logger 1 is expanded in the X-Y plane, and the thickness thereof in the Z-axis direction can be suppressed from increasing, for example, compared to the foregoing first embodiment. Consequently, the shock logger 1 is suitable for a situation in which a slim design takes precedence over a small-footprint. In the embodiment, a second step surface 714 is not formed in a base 71, and second internal terminals 742 for the vibrator element 3 are disposed on a bottom surface 712 of the recess 711.

Such a fifth embodiment can produce the same effects as in the foregoing first embodiment. However, the configuration of the shock logger 1 is not particularly limited; however, by combining the present embodiment with the foregoing embodiment, for example, the circuit element 5 and the acceleration sensor 4 may be stacked to constitute a stacked body H. Furthermore, the base 71 may have a recess 719, and the battery 6 may be disposed on a bottom surface of the recess 719.

### Sixth Embodiment

FIG. 15 is a top view of a shock logger according to a sixth embodiment. In FIG. 15, for convenience of description, members unnecessary for the description, such as connection terminals P3 and wires W, are not illustrated.

A shock logger 1 according to the present embodiment is the same as that according to the foregoing fifth embodiment, except for a configuration of a circuit element 5. In the following description, the present embodiment will be described with a focus on differences from the foregoing first embodiment, and the description of the same matters will not be repeated. In addition, in the drawing according to the present embodiment, the same reference numerals are assigned to the same configurations as those according to the foregoing embodiment.

In the foregoing fifth embodiment, the circuit element 5 is formed with a single chip. In the present embodiment, however, the circuit element 5 is formed with a plurality of chips. More specifically, as illustrated in FIG. 15, the circuit element 5 includes a plurality of separate circuit elements: a first circuit element 5A in which an oscillation circuit 51 and a control circuit (not illustrated) are formed; a second circuit element 5B in which a timing circuit 52 is formed; a third circuit element 5C in which a sensor circuit 53 is formed, a fourth circuit element 5D in which a memory circuit 54 is formed; and a fifth circuit element 5E in which an interface circuit 55 is formed. By forming the circuit element 5 with a plurality of chips in this manner, the circuit element 5 can be disposed with a high degree of freedom.

Such a sixth embodiment can produce the same effects as in the foregoing fifth embodiment. However, the configuration of the shock logger 1 is not particularly limited; however, for example, the circuit element 5 may be formed with two to four or six or more separate chips. It should be noted that one or two or more circuits included in each circuit element can be combined together as appropriate.

### Seventh Embodiment

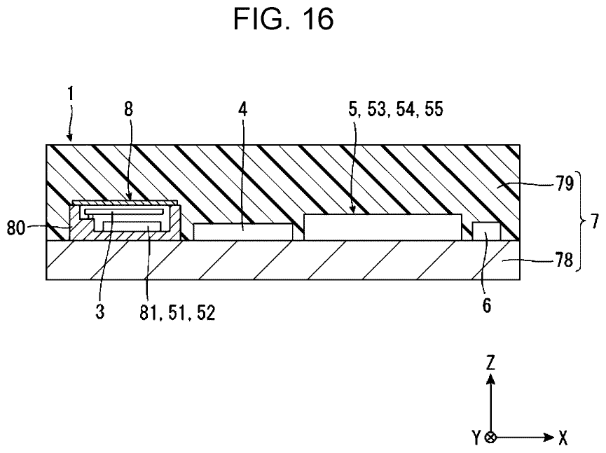

FIG. 16 is a cross-sectional view of a shock logger according to a seventh embodiment.

A shock logger 1 according to the present embodiment is the same as that according to the foregoing fifth embodiment, except for configurations of a real-time clock RTC and a package 7. In the following description, the present embodiment will be described with a focus on differences from the foregoing first embodiment, and the description of the same matters will not be repeated. In addition, in the drawing according to the present embodiment, the same reference numerals are assigned to the same configurations as those according to the foregoing embodiment.

In the shock logger 1 according to the present embodiment, the package 7 includes: a base 78 having a planar shape; and a molded section 79 that encapsulates sections disposed on the base 78. With this configuration, the package 7 is made simple.

The base 78, which has a planar shape, is formed of, for example, ceramics or a flexible printed circuit board (FPC). On the upper surface of the base 78, a vibrator device 8, an acceleration sensor 4, a circuit element 5, and a battery 6 are disposed. In this case, the vibrator device 8 serves as a real-time clock RTC. The vibrator device 8 includes: a package 80; and a vibrator element 3 and the circuit element 81 disposed inside the package 80. In addition, an oscillation circuit 51 and a timing circuit 52 are formed in the circuit element 81. Thus, the remaining circuits, such as a sensor circuit 53, a memory circuit 54, an interface circuit 55, and a control circuit (not illustrated), are formed in the circuit element 5. When the vibrator element 3 is exposed inside the package 7 as in the foregoing first embodiment, the vibrator element 3 cannot be encapsulated. However, by disposing the vibrator element 3 inside the package 80 as in the present embodiment, the vibrator element 3 can be encapsulated.

The molded section 79 encapsulates the vibrator device 8, the acceleration sensor 4, and the circuit element 5, thereby protecting the vibrator device 8, the acceleration sensor 4, and the circuit element 5 from moisture, dust, shock, and other external matter. A molding material of the molded section 79 is not particularly limited; however, for example, a thermosetting epoxy resin or other curable resin materials can be used. The molded section 79 can be formed by, for example, a transfer or other molding method.

With this configuration, the package 7 is formed with a solid structure. Thus, a natural vibration frequency fr of the shock logger 1 can be made higher than frequencies (33 Hz to 100 Hz) of shocks to be generated during the transportation. Therefore, the shock logger 1 can more effectively reduce resonance with shocks during the transportation, thereby detecting shocks more accurately.

In the shock logger 1 according to the present embodiment, as described above, the package 7 includes the molded section 79 that encapsulates the circuit element 5 and the acceleration sensor 4. With this configuration, the package 7 is made simple. In addition, because of the solid structure of the package 7, the natural vibration frequency fr of the shock logger 1 can be increased. Therefore, it is possible to more effectively reduce resonance with shocks during the transportation, thereby detecting shocks more accurately.

Such a seventh embodiment can produce the same effects as in the foregoing fifth embodiment.

Although a shock logger of the present disclosure has been described based on the illustrated embodiments, the present disclosure is not limited to such embodiments. A configuration of each section can be replaced with another configuration having substantially the same function.

Moreover, any other configurations may be added to the present disclosure. For example, the battery 6 does not necessarily have to be used when electric power can be supplied externally.

What is claimed is:

1. A shock logger comprising:
an acceleration sensor;
a circuit element including a timing circuit that generates time data, a sensor circuit that processes a signal output from the acceleration sensor, and a memory circuit that stores process data processed by the sensor circuit and the time data in relation to each other; and
a package that houses the acceleration sensor and the circuit element, wherein the shock logger has a natural vibration frequency less than 33 Hz or more than 100 Hz.

2. The shock logger according to claim 1, wherein
the natural vibration frequency is less than 25 Hz or more than 1 kHz.

3. The shock logger according to claim 2, wherein
the natural vibration frequency is less than 20 Hz or more than 10 kHz.

4. The shock logger according to claim 1, further comprising
a battery that supplies electric power to the circuit element.

5. The shock logger according to claim 4, wherein the battery is exposed to an outside of the package.

6. The shock logger according to claim 1, further comprising
a vibrator element disposed inside the package, wherein the circuit element includes an oscillation circuit that causes the vibrator element to oscillate, and
a real-time clock is configured by the oscillation circuit causing the vibrator element to oscillate to generate a clock signal, and the timing circuit performing clocking based on the clock signal to generate the time data, so that the oscillation circuit and the timing circuit constitute.

7. The shock logger according to claim 1, wherein
the package has a base on which the acceleration sensor and the circuit element are disposed, and
the acceleration sensor and the circuit element are disposed on the base in a stacked state.

8. The shock logger according to claim 7, wherein
the circuit element is disposed on the base, and
the acceleration sensor is disposed on the circuit element.

9. The shock logger according to claim 7, wherein
the acceleration sensor is disposed on the base, and
the circuit element is disposed on the acceleration sensor.

10. The shock logger according to claim 7, wherein
the package includes a lid bonded to the base, and the circuit element and the acceleration sensor are disposed between the package and the lid.

11. The shock logger according to claim 7, wherein
the package includes a molded section that encapsulates the circuit element and the acceleration sensor.

12. The shock logger according to claim 1, wherein
the circuit element includes a temperature sensor circuit that detects temperature, and
the memory circuit stores temperature data detected by the temperature sensor circuit, the process data, and the time data in relation to each other.
